(19) United States
(12) Patent Application Publication
(10) Pub. No.: US 2025/0105270 A1
(43) Pub. Date: Mar. 27, 2025

(54) LITHIUM MANGANESE RICH OXIDES WITH PROTECTIVE COATING FOR CATHODES

(71) Applicant: GM Global Technology Operations LLC, Detroit, MI (US)

(72) Inventors: Vamakshi Yadav, Sterling Heights, MI (US); Devendrasinh Darbar, Sterling Heights, MI (US); Raneen Taha, Sterling Heights, MI (US); Wei Li, Troy, MI (US)

(21) Appl. No.: 18/471,510

(22) Filed: Sep. 21, 2023

(51) Int. Cl. H01M 4/505; H01M 4/04; H01M 10/0525

(52) U.S. Cl. CPC H01M 4/505; H01M 4/0404; H01M 4/0471; H01M 10/0525

(57) ABSTRACT

A cathode active particles for use in a cathode of a lithium ion battery comprising a core includes a lithium-manganese-rich oxide and a coating on the core, wherein the coating includes a lithium manganese spinel. The cathode active particle can be made by preparing a dispersion of particles comprising a lithium-manganese-rich metal oxide in an aqueous solution of a salt of a transition metal oxide. The dispersion is mixed, and heated to a temperature in a range of 60 to 125° C. The solids are separated from the dispersion, and calcined. The cathode active particles can be used in cathode and in a battery comprising such cathode.

### INTRODUCTION

The subject disclosure relates to coated lithium manganese rich metal oxides, a process for making such coated lithium manganese rich metal oxides, and their use in cathodes.

Lithium manganese rich (LMR) oxides can provide batteries or electrochemical cells with higher specific capacity than cathode active materials such as lithium iron phosphate (LFP) and lithium nickel manganese cobalt oxide (NMC) cathode materials. However, performance of a battery having LMR-based cathodes can degrade over long term activity. For example, significant voltage fading (loss of capacity) can occur in such a battery from the cycling of the battery in charging and discharging.

It would be desirable to have an LMR based active material with improved capacity retention.

### SUMMARY

In one exemplary embodiment, disclosed herein are cathode active material particles for use in a cathode of a lithium ion battery having a core which includes a lithium-manganese-rich oxide and a coating on the core, wherein the coating includes a lithium manganese spinel.

In addition to one or more of the features described herein, the coating on the cathode active material particles can include a lithium manganese oxide represented by a formula LiMₐMn₍₂₋ₐ₎O₄, where M is a transition metal selected from nickel, cobalt, molybdenum, tungsten, chromium, niobium or a combination thereof, a is greater than or equal to 0 and less than 0.5.

In addition to one or more of the features described herein, the cathode active material particles can have an average particle size 3 to 20 microns and the coating on the core has a thickness of 0.5 to 20 nm.

In addition to one or more of the features described herein, the lithium-manganese-rich oxide of the cathode active particles can be represented by a formula xLi₂MnO₃·(1−x)LiMeO₂, where x is greater than 0 and less than 1, and Me is a transition metal. Particularly, the transition metal Me can be Mn, Ni, Co, or a combination thereof. Furthermore, when the transition metal Me is a combination of Mn and Ni a molar ratio of Mn:Ni can be in a range of 2:3 to 9:1.

In addition to one or more of the features described herein, the coating can include molybdenum in amounts of less than 0.1 weight, preferably less than 0.05 weight % based on total weight of the particles.

In another exemplary embodiment disclosed herein is a method which includes preparing a dispersion of particles comprising a lithium-manganese-rich metal oxide in an aqueous solution of a salt of a transition metal oxide. The salt of the transition metal oxide has two or more transition metal atoms, the salt of the transition metal oxide includes Niobium as the transition metal, or both. The dispersion is mixed, and then while mixing, heated to a temperature in a range of 60 to 125° C. After heating the solids are separated from the dispersion, and calcined to form coated particles comprising a lithium-manganese-rich metal oxide bearing a coating comprising a lithium manganese spinel.

In addition to one or more of the features described herein, in the coating formed in the method can include a lithium manganese oxide represented by a formula LiMₐMn₍₂₋ₐ₎O₄, where M is a transition metal selected from nickel, cobalt, molybdenum, tungsten, chromium, niobium or a combination thereof, a is greater than or equal to 0 and less than 2.

In addition to one or more of the features described herein, the aqueous solution used in the method can be a solution of ammonium heptamolybdate, ammonium tungstate, ammonium paratungstate, potassium dichromate, or ammonium niobate oxalate, and preferably is a solution of ammonium heptamolybdate.

In addition to one or more of the features described herein, the aqueous solution used in the method can the aqueous solution used in the method can have a weight percent of molybdenum in a range of 0.01 to 0.5 weight percent based on weight of the particles.

In addition to one or more of the features described herein, the mixing occurs at an initial temperature of 10 to 30° C. for a time of 0.5 to 24 hours and the heating of the dispersion occurs for 0.5 to 5 hours.

In addition to one or more of the features described herein, the calcining includes heating the solids at a temperature of 300 to 900° C. for 0.5 to 5 hours.

In addition to one or more of the features described herein, the separating includes filtering and the method further includes rinsing and drying the solids before calcining.

In addition to one or more of the features described herein, the method can further include forming on a cathode current collector a cathode active layer comprising the coated particles. The method can also further include assembling an electrolytic cell by positioning the cathode active layer on the cathode current collector opposite an anode layer on anode current collector on either side of a separator and providing an electrolyte to transport ions to or from the cathode active layer and/or the anode active layer.

In yet another exemplary embodiment disclosed is an article comprising a cathode layer comprising cathode active particles comprising a core which includes a lithium-manganese-rich oxide and a coating on the core, wherein the coating includes lithium manganese spinel.

In addition to one or more of the features described herein, the coating on the cathode active particles of the article can include a lithium manganese oxide represented by a formula LiMₐMn₍₂₋ₐ₎O₄, where M is a transition metal selected from nickel, cobalt, molybdenum, tungsten, chromium, niobium, or a combination thereof, a is greater than or equal to 0 and less than 0.5.

In addition to one or more of the features described herein, the article can be a battery comprising the cathode layer on a cathode current collector, an anode layer on an anode current collector, and between the cathode layer and the anode layer, a separator, and an electrolyte for transporting ions to or from the cathode active layer and/or the anode active layer.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic of a cross-section of an example of the lithium magnesium rich oxide cathode active materials bearing a coating as described herein;

FIG. 2 is a schematic of a cross section of an example of a battery cell including cathode electrodes including lithium magnesium rich oxide cathode active materials bearing a coating as described herein;

FIG. 3 is a plot of specific current versus voltage as described in Example 2;

FIG. 4 is a plot of discharge capacity versus cycle number as described in Example 3; and

FIG. 5 is a plot of discharge capacity retention versus cycle number as described in Example 3.

### DETAILED DESCRIPTION

The following description is merely exemplary in nature and is not intended to limit the present disclosure, its application or uses. It should be understood that throughout the drawings, corresponding reference numerals indicate like or corresponding parts and features.

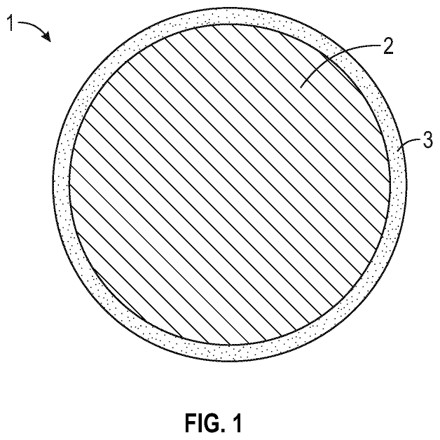

In accordance with an exemplary embodiment disclosed are cathode active particles having a core including lithium-manganese-rich oxide and a coating on the core. As shown in FIG. 1, the particles 1 can include a core 2 and a coating 3.

By lithium rich is meant that the molar ratio of lithium to other metals (e.g., nickel, manganese, and optionally an additional transition metal such as Co, Ti, Al, Fe, etc.) in the active material is greater than 1:1, e.g., 1.1:1 up to 1.80:1 or up to 1.49:1. For example, the lithium-manganese rich oxide can be represented by the formula xLi₂MnO₃·(1−x)LiMeO₂, where x is greater than 0 and less than 1, preferably less than or equal 0.5, and Me is a transition metal. The transition metal Me can be, for example, Mn, Ni, Co, or a combination thereof. As one particular, example, the transition metal Me is a combination of Mn and Ni in a molar ratio of Mn:Ni in the range of 2:3 to 9:1.

The coating 3 can include a lithium manganese spinel structure. The coating can include a lithium manganese oxide represented by a formula LiMₐMn₍₂₋ₐ₎O₄, where M is a transition metal, a is greater than or equal to 0 and less than 2, less than 1 or less than 0.5. The transition metal, M, if present can include nickel, cobalt, molybdenum, niobium, tungsten, chromium, or a combination or two or more thereof. As an example, the coating can include lithium manganese spinel, having a formula, Li_{y}Mn₂O₄ where y is greater than zero and less than or equal to 2, or less than or equal to 1, or, for example y is 1 or a formula LiNiₐMn₍₂₋ₐ₎O₄ where a is from greater than 0 to 0.5, or a combination thereof.

The cathode active material particles 1 may have an average particle size of, for example, 3 to 20, or 5 to 10 microns. Particle size can be determined using a particle size analyzer, such as, dynamic light scattering or electron microscopy imaging. The coating 3 may have a thickness of 0.5 to 20 nm. Thickness may be measured, for example, using transmission electron microscopy.

The cathode active material particles 1 can be made by preparing a dispersion of particles including a lithium-manganese-rich metal oxide in an aqueous solution of transition metal oxide salt. The transition metal oxide salt can be a salt having 2 or more transition metal atoms or a Niobium oxide salt. For example, the salt can be ammonium heptamolybdate ((NH₄)₂Mo₇O₂₄), ammonium tungstate ((NH₄)₂W₇O₂₄), ammonium paratungstate ((NH₄)₁₀(H₂W₁₂O₄₂)), potassium dichromate (K₂Cr₂O₇), ammonium niobate oxalate (C₄H₄NNbO₉), or a combination of two or more thereof.

The concentration of the aqueous solution can be based on the amount of the transition metal of the transition metal oxide salt relative to the weight of the particles including a lithium-manganese-rich metal oxide. The transition metal of the transition metal oxide salt can be present in a weight percent of, as examples, from 0.001, from 0.005, from 0.01, from 0.02, or from 0.03 up to 2, up to 1, up to 0.5, up to 0.3, up to 0.1, up to 0.08, or up to 0.05 weight percent based on weight of the particles. As another example, the solution can include molybdenum in a range of from 0.001, from 0.005, from 0.01, from 0.02, or from 0.03 up to 2, up to 1, up to 0.5, up to 0.3, up to 0.1, up to 0.08, or up to 0.05 weight percent based on weight of the particles based on weight of the particles.

The particles including a lithium-manganese-rich metal oxide can be added to the aqueous solution including the transition metal oxide salt while mixing (e.g., stirring). The combination can be mixed at a temperature of 10 to 30° C. for up to 24 hours, for example 0.2 to 24 hours, or 0.5 to 10 hours, or 1 to 5 hours. The mixture is then heated range of 60 to 125° C., or 65 to 100, or 70 to 90° C. The heated combination can be maintained at that temperature for 0.5 to 5 hours or 0.75 to 3 hours. The heated combination can be mixed during this elevated temperature step.

The solids may then be separated from the liquids of the dispersion. The separation can occur, for example, by filtering or centrifuging the dispersion. The separated solids can be rinsed in water and dried. The separated solids can then be calcined. For example, the calcining may include heating the solids at a temperature of 300 to 900, or 350 to 700, or 400 to 500° C. for 0.5 to 5 hours, or 1 to 3 hours.

The coated lithium-manganese rich oxide particles 1 may be used to form a cathode. The cathode can include, in addition to the particles 1 a binder and/or conductive elements. As the binder a polymer can be used. Examples of polymer binders include polyvinylidene fluoride (PVDF), polytetrafluoroethylene (PTFE), ethylene propylene diene (EPDM) rubber, styrene butadiene rubber (SBR), carboxymethyl cellulose (CMC), nitrile butadiene rubber (NBR), styrene-butadiene rubber (SBR), styrene ethylene butylene styrene copolymer (SEBS), polyacrylates, alginates, polyacrylic acid, or combinations thereof. Examples of conductive elements include carbon black, graphene, carbon nanotubes, or a combination of two or more thereof. The cathode can include 70 to 99, 80 to 98.5, 90 to 98 weight percent of cathode active particles based on total weight of the cathode. The cathode can include the conductive elements in amounts up to 25 weight percent—for example, from 0.25, from 0.5, or from 1 weight percent up to 25, up to 20, up to 10, or up to 5 weight percent based on total weight of the cathode. The cathode can include the binder in amounts up to 25 weight percent—for example, from 0.25, from 0.5, or from 1 up to 25, up to 20, up to 10, or up to 5 weight percent based on total weight of the cathode.

The cathode active materials can be the coated lithium-manganese rich oxide particles 1 or can be a combination or the coated lithium-manganese rich oxide particles 1 with another cathode active material. Such other cathode active material can include, for example, metal oxides or phosphates such as lithium manganese oxide (Li₍₁₊ₓ₎Mn₂O₄, where 0.1≤x≤1) (LMO), lithium nickel manganese oxide (LiNi_{0.5}Mn_{1.5}O₄) (LNMO), lithium cobalt oxide (LiCoO₂) (LCO), lithium nickel manganese cobalt oxide (LiNi_{1-x-y}CoₓMn_{y}O₂) (where 0≤x≤1 and 0≤y≤1) (NMC), lithium cobalt manganese aluminum oxide (LiNi_{1-x-y-z}CoₓMn_{y}Al_{z}O₂, where 0.0<x+y+z<0.25) (NCMA), lithium iron phosphate (LiFePO₄), lithium vanadium phosphate (LiVPO₄), lithium manganese iron phosphate (LiMn₁₋ₓFeₓPO₄, where 0≤x≤1), and combinations thereof. The amount of such additional metal oxides can be from 0, from 0.5, from 1, from 2, from 3, from 5, from 5 up to 60, up to 50, up to 40, up to 30, up to 20, or up to 10 weight percent based on total weight of the active material. The cathode active material can be free of cobalt.

A slurry comprising the cathode active material, any binder and any conductive material and a carrier solvent can be prepared and the slurry applied to a cathode current collector and dried.

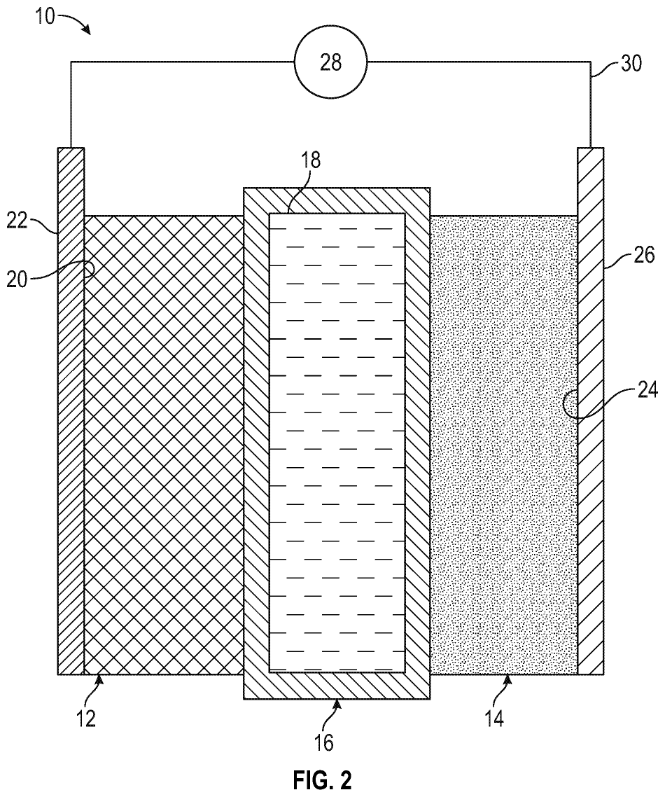

The cathode can be used in an electrochemical cell including the cathode, an anode, and an electrolyte. For example, as shown in FIG. 2, the electrochemical cell 10 can include a cathode 12, an anode 14 spaced apart from the cathode 12, and a porous separator 16 positioned between the positive and anodes 12, 14. The cathode and anode 12, 14 and the porous separator 16 are infiltrated with an electrolyte 18 that provides a medium for the conduction of lithium ions therethrough. The cathode 12 is disposed on a major surface 20 of a cathode current collector 22, and the anode 14 is disposed on a major surface 24 of an anode current collector 26. In practice, the cathode and anode current collectors 22, 26 may be electrically coupled to a power source or load 28 via an external circuit 30. The electrochemical cell 10 may be combined with one or more additional electrochemical cells to form a lithium-ion battery.

The anode 14 includes an active material. The active material can be, for example, graphite, a silicon-based graphite blend, or a silicon based particle. The anode 14 can also include a binder. The binder can be the same or different than the binder for the cathode. The binder can be, for example poly(tetrafluoroethylene) (PTFE), sodium carboxymethyl cellulose (CMC), polyvinyl alcohol (PVA), polyacrylic acid (PAA), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS), lithium polyacrylate (LiPAA), sodium polyacrylate (NaPAA), sodium alginate, lithium alginate, ethylene propylene diene monomer (EPDM), and combinations thereof. The anode can include conductive elements such as carbon black, graphene, carbon nanotubes or combinations thereof.

The separator 16 can include, for example, a polymeric film, such as a polypropylene film or a coated polypropylene film. The separator may include a polyolefin-based material having the general formula (CH₂CH_{R})ₙ, where R is an alkyl group. In aspects, the separator 16 may include a single polyolefin or a combination of polyolefins. Examples of polyolefins include polyethylene (PE), polypropylene (PP), polyamide (PA), poly(tetrafluoroethylene) (PTFE), polyvinylidene fluoride (PVdF), poly(vinyl chloride) (PVC), and/or polyacetylene. Examples of other polymeric materials that may be included in or used to form the separator 16 include cellulose, polyimide, copolymers of polyolefins and polyimides, poly(lithium 4-styrenesulfonate)-coated polyethylene, polyetherimide (PEI), bisphenol-acetone diphthalic anhydride (BPADA), para-phenylenediamine, poly(m-phenylene isophthalamide) (PMIA), and/or expanded polytetrafluoroethylene reinforced polyvinylidenefluoride-hexafluoropropylene.

The electrolyte 18 provides a medium for the conduction of lithium ions through the electrochemical cell 10 between the cathode 12 and the anode 14 and may be in solid, liquid, or gel form. In aspects, the electrolyte 18 may include a non-aqueous liquid electrolyte solution including a lithium salt dissolved in a non-aqueous aprotic organic solvent or a mixture of non-aqueous aprotic organic solvents. Non-limiting examples of lithium salts include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato) borate (LiB(C₂O₄)₂)(LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), lithium (triethylene glycol dimethyl ether)bis(trifluoromethanesulfonyl)imide (Li(G₃)(TFSI), lithium bis(trifluoromethanesulfonyl) azanide (LiTFSA), and combinations thereof. Non-limiting examples of non-aqueous aprotic organic solvents include cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ lactones (e.g., γ butyrolactone, γ valerolactone), chain structure ethers (e.g., 1,2 dimethoxyethane, 1 2 diethoxyethane, ethoxymethoxyethane), cyclic ethers (e.g., tetrahydrofuran, 2 methyltetrahydrofuran), 1,3-dioxolane).

### EXAMPLES

### Example 1—Preparation of Coated Lithium-Manganese-Rich Oxides

Lithium-manganese-rich metal oxide particles having a formula were added to an aqueous solution of ammonium heptamolybdate while stirring. For Sample A, the amount of the molybdenum in the solution was about 0.05 weight percent based on weight of the LMR particles. For Sample B, amount of the molybdenum in the solution in the solution was 2% based on the weight of the LMR particles. The combination was stirred at room temperature for 2 hours. The combination was then heated while stirring at 75° C. for one hour. The combination was filtered and the solid was collected, rinsed with water and dried. The solid was calcined at 450° C. for two hours to form coated LMR Samples A and B.

Samples A and B and the uncoated LMR were tested by powder x-ray diffraction (XRD) and the XRD showed no significant changes in peaks indicating that the bulk of Samples A and B retained the chemistry and structure of the uncoated LMR.

### Example 2—Formation of Electrochemical Cells

Each of the uncoated LMR particles and the Samples A and B, were separately combined with carbon black (CB) and polyvinylidene fluoride (PVDF) at weight ratios of LMR:CB:PVDF or 94:3:3 to each form a cathode layer on a cathode current collector. These cathodes were assembled into an electrochemical cells having a silicon oxide-graphite based anode, a microporous polypropylene monolayer) separator, and a LiPF₆ based electrolyte. A constant current and constant voltage (CCCV) protocol was used to charge the cells at a constant current using a C/20 charge rate to a potential of about 4.6 V, then constant voltage charge at 4.6V until the current reached C/50. The cells were subsequently discharged at a constant current using a C/20 discharge rate to 2.0 V. A total of 2 such charge and discharge cycles were performed during formation.

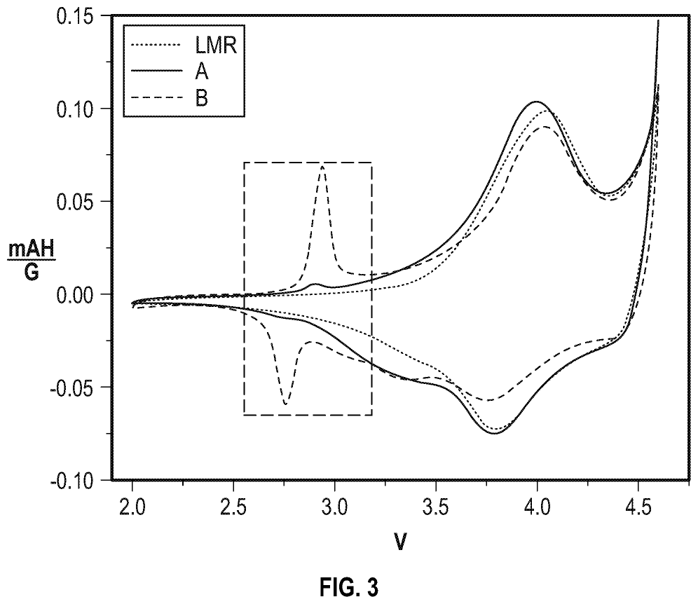

The cells made with uncoated LMR, with Sample A, and with Sample B were tested in cyclic voltammetry with the results shown in FIG. 3. The y-axis is Specific Current in milliAmpere-hours/gram and the x-axis is Voltage. The box shows evidence of formation of spinel structures such as LiMn₂O₄ and Li₂Mn₂O₄

### Example 3

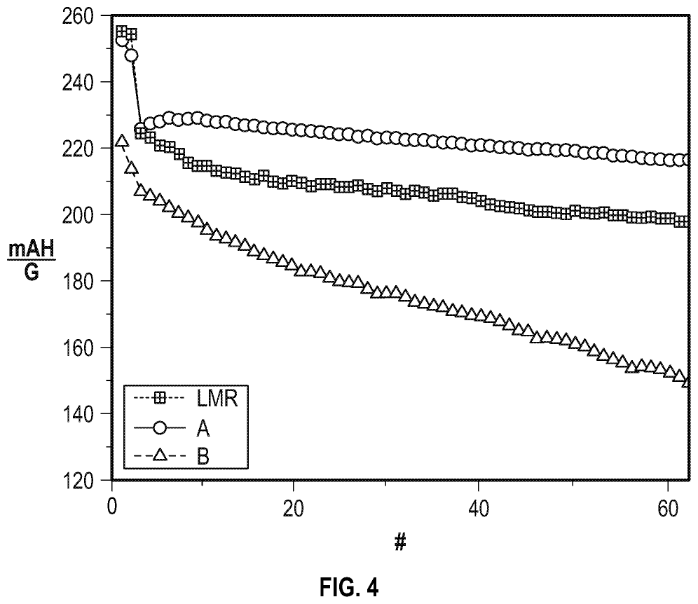

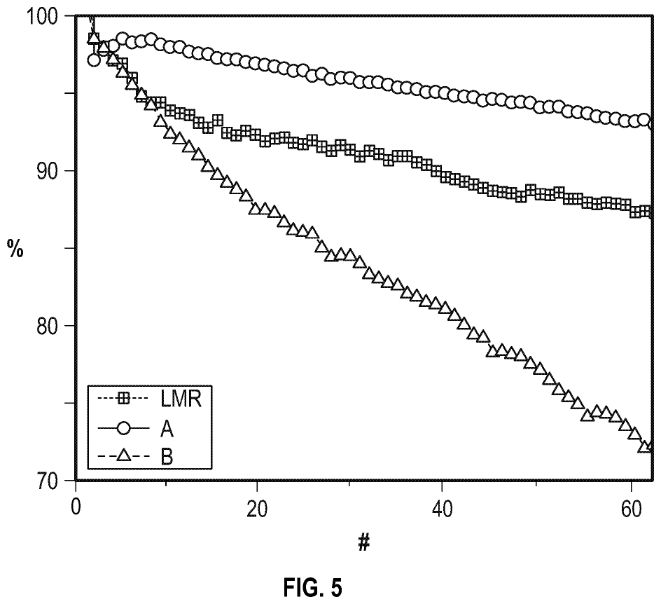

Electrochemical cells as described in Example 2 were tested for life cycle protocol by cycling between 2.0-4.6 V using the following CCCV protocol: A constant current and constant voltage (CCCV) protocol was used to charge the cells at a constant current using a C/3 charge rate to a potential of about 4.6 V, then constant voltage charge at 4.6V until the current reached C/20. The cells were subsequently discharged at a constant current using a C/3 discharge rate to 2.0 V. FIG. 4 shows the discharge capacity in milliampere-hours/gram of the battery cell on the y axis and cycle number on the x-axis. FIG. 5 shows discharge capacity retention as a percentage of initial discharge capacity on the y axis versus cycle number on the x-axis. Sample A has better discharge capacity and discharge capacity retention than uncoated LMR. Sample B does not show improvement perhaps indicating that the surface coating is too thick and degrades performance. However, it is believed that with other LMR with different chemistry and/or morphology—e.g., more porous, may benefit from the higher percentage of transition metal in the salt of transition metal oxide used in the process.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A cathode active material particle for use in a cathode of a lithium ion battery comprising a core which comprises a lithium-manganese-rich oxide and a coating on the core, wherein the coating comprises a lithium manganese spinel.

2. The cathode active material particles of claim 1 wherein the coating comprises a lithium manganese oxide represented by a formula LiMₐMn₍₂₋ₐ₎O₄, where M is a transition metal selected from nickel, cobalt, molybdenum, tungsten, chromium, niobium or a combination thereof, a is greater than or equal to 0 and less than 0.5.

3. The cathode active material particles of claim 1 having an average particle size 3 to 20 microns and the coating on the core has a thickness of 0.5 to 20 nm.

4. The cathode active materials of claim 1 wherein the lithium-manganese-rich oxide is represented by a formula xLi₂MnO₃·(1−x)LiMeO₂, where x is greater than 0 and less than 1, and Me is a transition metal.

5. The cathode active material particles of claim 4 wherein the transition metal Me is Mn, Ni, Co, or a combination thereof.

6. The cathode active material particles of claim 4 wherein the transition metal Me is a combination of Mn and Ni in a molar ratio of Mn:Ni in a range of 2:3 to 9:1.

7. The cathode active material particles of claim 1 wherein the coating comprises molybdenum in amounts of less than 0.1 weight, preferably less than 0.05 weight % based on total weight of the particles.

8. A method comprising
preparing a dispersion of particles comprising a lithium-manganese-rich metal oxide in an aqueous solution of a salt of a transition metal oxide wherein the salt of the transition metal oxide has two or more transition metal atoms, the salt of the transition metal oxide comprises Niobium as the transition metal, or both,
mixing the dispersion,
while mixing, heating the dispersion to a temperature in a range of 60 to 125° C.,
after heating, separating solids from the dispersion,
calcining the solids to form coated particles comprising a lithium-manganese-rich metal oxide bearing a coating comprising a lithium manganese spinel.

9. The method of claim 8 wherein the coating comprises a lithium manganese oxide represented by a formula LiMₐMn₍₂₋ₐ₎O4, where M is a transition metal selected from nickel, cobalt, molybdenum, tungsten, chromium, niobium or a combination thereof, a is greater than or equal to 0 and less than 2.

10. The method of claim 8 wherein the aqueous solution is a solution of ammonium heptamolybdate, ammonium tungstate, ammonium paratungstate, potassium dichromate, or ammonium niobate oxalate.

11. The method of claim 8 wherein the aqueous solution is a solution of ammonium heptamolybdate.

12. The method of claim 11 wherein the solution has a weight percent of molybdenum in a range of 0.01 to 0.5 weight percent based on weight of the particles.

13. The method of claim 8 wherein the mixing occurs at an initial temperature of 10 to 30° C. for a time of 0.5 to 24 hours and the heating of the dispersion occurs for 0.5 to 5 hours.

14. The method of claim 8 wherein the calcining comprises heating the solids at a temperature of 300 to 900° C. for 0.5 to 5 hours.

15. The method of claim 8 wherein the separating comprises filtering and the method further comprises rinsing and drying the solids before calcining.

16. The method of claim 8 further comprising forming on a cathode current collector a cathode active layer comprising the coated particles.

17. The method of claim 16 further comprising assembling an electrolytic cell by positioning the cathode active layer on the cathode current collector opposite an anode layer on anode current collector on either side of a separator and providing an electrolyte to transport ions to or from the cathode active layer and/or the anode active layer.

18. An article comprising a cathode layer comprising cathode active particles comprising a core which comprises a lithium-manganese-rich oxide and a coating on the core, wherein the coating comprises lithium manganese spinel.

19. The article of claim 18 wherein the coating comprises a lithium manganese oxide represented by a formula LiMₐMn₍₂₋ₐ₎O₄, where M is a transition metal selected from nickel, cobalt, molybdenum, tungsten, chromium, niobium, or a combination thereof, a is greater than or equal to 0 and less than 0.5.

20. The article of claim 18 which is a battery comprising the cathode layer on a cathode current collector, an anode layer on an anode current collector, and between the cathode layer and the anode layer, a separator, and an electrolyte for transporting ions to or from the cathode active layer and/or the anode active layer.
